(19) United States
(12) Patent Application Publication
(10) Pub. No.: US 2004/0155228 A1
(43) Pub. Date: Aug. 12, 2004

(54) Electrically conducting, magnetic powder

(75) Inventor: Frank Dietrich, Ostfildern Kemnat (DE)

Correspondence Address: WILLIAM COLLARD, COLLARD & ROE, P.C., 1077 NORTHERN BOULEVARD, ROSLYN, NY, 11576, US

(73) Assignee: Metallux GmbH

(21) Appl. No.: 10/770,651

(22) Filed: Feb. 3, 2004

(30) Foreign Application Priority Data
Feb. 5, 2003 (DE) 103 04 794.8
May 22, 2003 (DE) 103 23 765.8

(51) Int. Cl. H01B 1/00

(52) U.S. Cl. 252/500

(57) ABSTRACT

The present invention relates to a powder (1) comprising electrically conducting and magnetic particles (2). An electrically conducting, magnetic powder (1) can for example, be used to transfer an electrical signal and/or an electric voltage and/or an electric current between at least two electrical contacts in an electrical component, especially in a potentiometer.

The present invention relates to an electrically conducting, magnetic powder.

In many electrical applications, electrically conducting connections must be produced between a plurality of electrical contacts, for example, in order to transfer an electrical control signal or an electric voltage or an electric current between the interconnected contacts. Primarily considered here are dynamic connections, that is connections which can be closed and opened or modified depending on pre-determined conditions.

For example, in the case of a switch, contacts arranged therein are joined together or separated from one another depending on an actuation of the switch. Such switches can be configured as limit switches, for example, which recognise different relative positions between the contacts and a connecting element for connecting the contacts. In the case of mechanical solutions, the connecting element is physically brought in contact with the contacts in order to produce the respective connection. Alternatively, electronically operating solutions are possible where the switch is actuated, for example, inductively, capacitively, optically, with ultrasound or using the Hall effect in order to generate the respectively desired switching signal.

Other applications are, for example, potentiometers where a collector track is arranged along a resistance track and where a connecting element connects the collector to the resistance. In this case, the connecting element is displaceable along the tracks, wherein the output signal of the potentiometer depends on the relative position of the connecting element along the tracks. In the case of a mechanical solution, the connecting element is usually configured as a slider. Since such solutions are liable to wear, electrical or electronic solutions which operate without contact and are thus free from wear are already being used here. Potentiometers are required for example for travel and angle sensors.

Dynamic connections which operate by physical or sliding contacting of the connecting element with the respective contacts can indeed be produced relatively cheaply but are liable to wear and are disadvantageous with regard to long life and reliability of the respective component. In contrast thereto, electronic systems can operate without contact so almost no wear occurs. However, electronic systems are comparatively expensive. Furthermore, a high reliability can only be ensured to a limited extent with electronic systems.

The present invention is concerned with the problem of demonstrating a method for the dynamic connection of at least two electrical contacts which can be implemented cheaply and makes it possible for a system operating therewith to have a long lifetime with a high reliability.

This problem is solved according to the invention by the subject matter of the independent claims. Advantageous embodiments are the subject matter of the dependent claims.

The invention is based on the general idea of providing an electrically conducting and magnetic or ferromagnetic powder. Such a CMP (conductive magnet powder) combines two properties, namely the capability of being influenced by magnetic forces on the one hand and electrical conductivity on the other hand. It is hereby possible to manipulate the CMP by means of magnetic forces, that is especially without contact in order to move the CMP relative to electrical contacts. Furthermore, two or more electrical contacts can be interconnected using the CMP since the CMP according to the invention is sufficiently electrically conducting. Equally it is possible to position the CMP along contacts, for example, in a potentiometer. A physical contact between the CMP and the respective contacts is also involved here but coefficients of friction between the relatively small particles and a solid can be extremely small. Accordingly, the electrical contacts come in contact with the CMP almost free from wear.

Using the CMP a connecting element can be provided in an electrical component which can be displaced by means of magnetic forces relative to the respective contacts without contact. Wear-free operating systems which work reliably and have a long lifetime can hereby be achieved.

In this context, it is especially possible to accommodate the CMP and the respective contacts in one, especially hermetically sealed, casing and to arrange the casing such the magnetic forces for displacing the CMP can act on the CMP from outside through a wall in the casing. New areas of application are hereby opened up for the respective components.

Other important features and advantages of the invention are obtained from the dependent claims, from the drawings and from the relevant description of the figures with reference to the drawings.

It is understood that the aforesaid features to be explained in detail hereinafter can be used not only in the respectively given combination but also in other combinations or alone without departing from the scope of the present invention.

Preferred exemplary embodiments of the invention are shown in the drawings and will be explained in detail in the following description, wherein the same reference numbers refer to the same or functionally the same or similar components.

In the figures, in each case schematically,

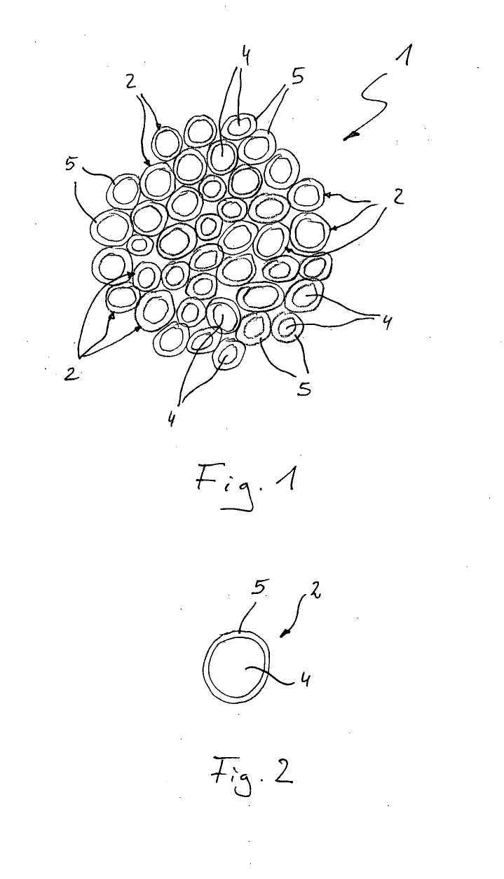

FIG. 1 shows a view of a volume of an electrically conducting, magnetic powder according to the invention,

FIG. 2 shows a view of an electrically conducting particle,

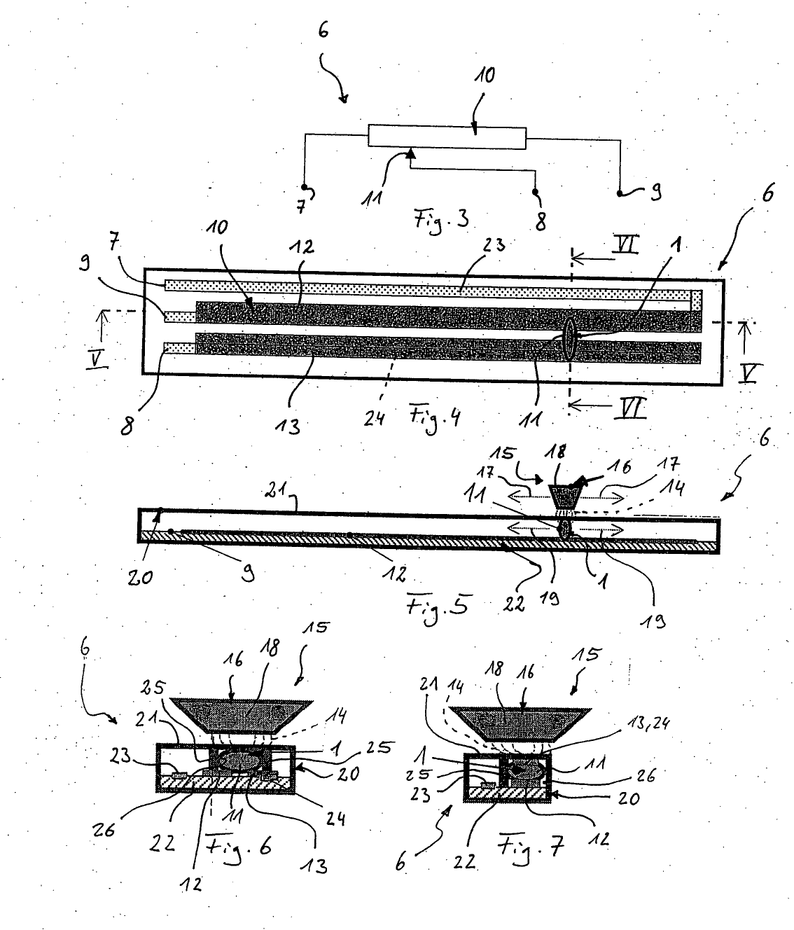

FIG. 3 shows a circuit diagram of a potentiometer,

FIG. 4 shows a simplified diagram of a potentiometric travel sensor viewed from the top,

FIG. 5 shows a longitudinal section through the travel sensor corresponding to the line of intersection V in FIG. 4,

FIG. 6 shows a cross-section through the travel sensor corresponding to the line of intersection VI in FIG. 4,

FIG. 7 shows a cross-section as in FIG. 6 but with a different embodiment of the travel sensor,

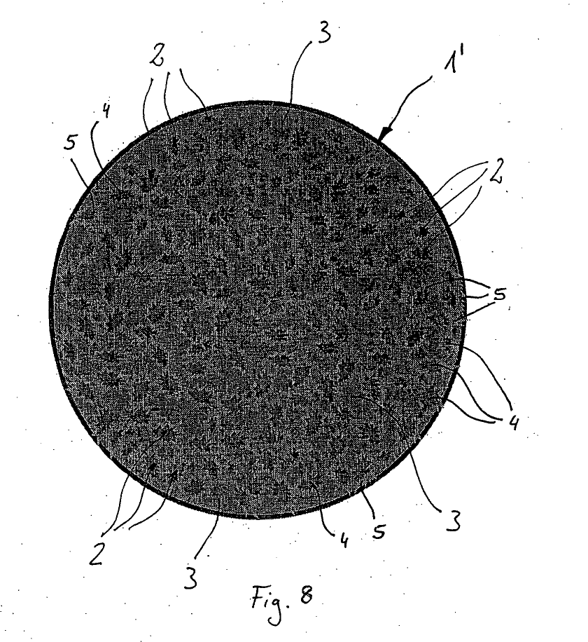

FIG. 8 shows a view of a volume of an electrically conducting, magnetic liquid according to the invention.

Accordingly, FIG. 1 contains a volume of an electrically conducting, magnetic powder 1 according to the invention, hereinafter also called CMP volume 1, electrically conducting, magnetic particles 2. The particles 2 can fundamentally consist of an arbitrary, magnetically attractable, i.e., ferromagnetic material. It is important that the particles 2 are attractable by magnetic forces. In this case, the particles 2 can be magnetically soft or magnetically hard. It can basically be sufficient to construct a pre-determined fraction of the particles 2 as electrically conducting and magnetic. Preferred however is a variant in which all the particles 2 of the powder 1 are electrically conducting and magnetic so that the powder 1 then also consists of electrically conducting and magnetic particles 2.

In a particular embodiment the particles 2 can consist of a magnetic and electrically conducting material. For example, the particles 2 can consist of iron or steel or nickel.

In another embodiment the particles 2 can have a magnetic core 4 which is provided with an electrically conducting coating 5. The magnetic core 4 can then consist of an electrically non-conducting material. For example, the cores 4 consist of ferrite which is used as the basic material for the manufacture of magnetic bodies, e.g. in generators or electric motors. In this case, the surface of the core 4 need not be completely coated and equally not all the cores 4 need be provided with the coating 5. Preferred however is an embodiment in which the cores 4 are completely coated on their surface and/or in which all the cores 4 are provided with the coating 5. The concentration of the electrically conducting particles 2 in the powder 1 is selected depending on the selected electrical conductivity of the CMP volume 1.

The electrical coating 5 of the cores 4 can, for example, be achieved with carbon or with a metal, especially with a more or less rare metal.

The particles 2 are preferably pre-magnetised. This has the consequence that the individual particles 2 mutually attract like small magnets and conglomerate to form a cohesive volume. Such a volume or conglomerate of the magnetised particles 2 behaves dynamically almost as a liquid. In order to achieve especially low friction values between the individual particles 2 inside the powder 1 (internal friction) and/or between the powder 1 and for example, an electrical contact (external friction), the particles 2 can have a relatively small average grain size which is especially smaller than 50 μm or smaller than 40 μm or smaller than 35 μm. Additionally or alternatively the internal friction or the external friction can also be reduced by the fact that the particles 2 are constructed as spherical or approximately spherical. The powder 1 then has a substantially spherical grain.

In accordance with FIG. 8, it is also possible to bind the powder 1 into a liquid or carrier liquid 3, whereby the friction can also be reduced. An electrically conducting and magnetic liquid 1′ (Conductive Magnet Fluid or CMF for short) can hereby be produced. The carrier liquid 3 used for this purpose can then form a dispersion with the particles 2 contained therein. An oil, for example, is suitable as carrier liquid 3. A carrier liquid 3 which has a relatively high surface tension is advantageous. A high surface tension brings about a relatively strong cohesion of the CMF volume 1′ thus formed and counteracts any creep as well as any adhesion of the carrier liquid 3 to a body in contact therewith. An embodiment in which a non-migrating oil is used as carrier liquid 3 is especially advantageous.

For illustration FIG. 2 shows an individual particle 2 having a magnetic core 4 which is provided on its outside with an electrically conducting coating 5.

The electrically conducting, magnetic powder 1 according to the invention can be manufactured particularly simply by providing electrically conducting and magnetic particles 2 in a pourable grain size. The electrically conducting and magnetic particles 2 can be manufactured, for example, by providing magnetic cores 4 with an electrically conducting coating 5.

The CMP volume 1 or the electrically conducting, magnetic powder 1 according to the invention is especially suitable for use in an electrical component for transferring an electrical signal and/or an electric voltage and/or an electric current between at least two electrical contacts.

Taking a potentiometer as an example, an electrical component is described in FIGS. 3 to 7 in which the electrically conducting, magnetic powder 1 according to the invention can be used without restricting the generality. It is clear that two or more electrical contacts can be dynamically interconnected using the electrically conducting, magnetic powder 1 according to the invention basically also in other electrical components.

In accordance with FIG. 3, a potentiometer 6 has three connections 7, 8, 9 and a resistance 10 on which the connection designated as 8 can act with a connecting element 11 symbolised by an arrow at different positions, i.e. at different resistance values. Depending on the positioning of the connecting element 11, the potentiometer 6 generates output signals at its connections 7, 8, 9 which can be evaluated in a corresponding circuit.

FIG. 4 shows an embodiment in which the potentiometer 6 is configured as a linear travel sensor. The potentiometer 6 contains a resistance track 12 which forms a first electrical contact and a collector track 13 which forms a second electrical contact. In this case, the connecting element 11 is formed by a volume, especially a drop-shaped conglomerate, of the electrically conducting, magnetic powder 1 and is thus hereinafter designated as the actuating volume 11 or CMP volume 1. The actuating volume 11 or the CMP volume 1 is thus positioned such that the CMP volume 1 contacts both the collector track 13 and the resistance track 12. It is clear that a volume of the electrically conducting, magnetic liquid 1′ (CMF volume) described above can fundamentally also be used in a suitable fashion. The following reasoning thus applies fundamentally also to a CMF volume 1′

The positioning of the CMP volume 1 is achieved in accordance with FIG. 5 by means of magnetic forces 14 which are symbolised by broken lines in FIG. 5. The magnetic forces 14 are generated by an actuating device 15. In the embodiment shown here this actuating device 15 has an actuator 16 which is displaceable according to the arrows 17 relative to the contacts or tracks 12, 13 of the potentiometer 6. In order to generate the magnetic forces 14, the actuator 16 can contain at least one magnet 18 which can be configured as a permanent magnet or an electromagnet.

In the event of a relative displacement of the actuator 16 relative to the contacts or tracks 12, 13, a magnetic field generated by the magnetic forces 14 is accordingly displaced with it. Since the magnetic forces 14 act on the CMP volume 1, the volume 11 follows the displacement movements of the actuator 18 which is indicated by corresponding arrows 19 in FIG. 5. The positioning of the volume 11 along the tracks or contacts 12, 13 can thus be changed by displacement of the actuator 18 whereby the output signal of the potentiometer 6 changes in a corresponding fashion.

If the potentiometer 6 is used as a travel sensor, the actuator 16 can be connected to an object whose relative movements should be recorded with the travel sensor.

As can be seen clearly from FIG. 5, the contacts 12, 13 or the resistance track 12 and the collector track 13 as well as the CMP volume 1 can be accommodated in a casing 20 which is suitably hermetically sealed towards the outside. In this case, this casing 20 is arranged as permeable for the magnetic forces 14 at least on one wall 21 opposite the tracks or contacts 12, 13. The actuating device 15 arranged outside the casing 20 or outside on the casing 20 can thus act through the wall 21 on the CMP volume 1. Accordingly a relative displacement of the actuator 16 along the outside of the casing 20 causes a corresponding relative displacement of the CMP volume 1 in the casing 20. In accordance with FIG. 5, the actuator 16 can advantageously be positioned relative to the casing 20 such that it is at a distance from the casing 20, i.e., is displaceable along the casing 20 without contact.

The application of the electrically conducting, magnetic powder 1 in the potentiometer 6 according to the invention to achieve dynamic contacting of the tracks or contacts 12, 13 results in minimal friction between the CMP volume 1 and the surface of the contacts or tracks 12, 13. The forces for displacing the CMP volume 1 are thus very small. Furthermore, almost no wear of the contacts or tracks 12, 13 and of the CMP volume 1 occurs whereby the lifetime and reliability of the potentiometer 6 is increased. Finally, the non-contact arrangement of the actuator 16 relative to the casing 20 results in minimal friction or no friction so that wear can also be avoided here. Another advantage of the overall extremely reduced friction can be seen in the fact that the displacement forces required to displace the potentiometer 6 are extremely small so that the potentiometer 6 can be configured as a precision instrument.

The resistance track 12 and the collector track 13 can, for example, be applied to a substrate 22 in the form of a conductive plastic, so-called conductive plastic. In accordance with FIG. 6, two conductor tracks 23, 24 are embedded in the substrate 22, of which one leads to the connection designated as 7 and is connected to the resistance track 12. The other conductor track 24 leads to the connection designated as 8 and is covered by the collector track 13. At its ends the resistance track 12 is connected firstly to the conductor track 23 and secondly to the connection designated as 9.

In the embodiment in accordance with FIG. 6 longitudinal cross-pieces 25 are also arranged in the casing 20, which here are supported on the tracks or contacts 12, 13. The longitudinal cross-pieces 25 are not electrically conducting and between them enclose a channel 26 in which the CMP volume 1 is accommodated and is displaceable along the tracks 12, 13. The CMP volume 1 is hereby enclosed in a defined space so that the volume 11 can be continuously reformed if it should be divided by vibrations for example.

Whereas in the embodiment in accordance with FIG. 6, the collector track 13 and the resistance track 12 are arranged next to one another in one plane on the substrate member 22, FIG. 7 shows another embodiment in which the resistance track 12 and the collector track 13 are located together but lie opposite one another in different planes. In this embodiment the potentiometer 6 can be constructed comparatively compactly, e.g. only one longitudinal cross-piece 25 is required to separate the channel 26. The required CMP volume 1 is also reduced.

In the embodiments shown here the actuating device 15 has the actuator 16 which can be displaced relative to the contacts or tracks 12, 13 and in this case brings about the corresponding positioning of the CMP volume 1. In another embodiment the actuating device 15 can have a magnetic force generator which is constructed in the fashion of a linear motor. This magnetic force generator then extends along a pre-determined displacement path for the CMP volume 1. In the present case, the magnetic force generator would then extend along the tracks or contacts 12, 13. The magnetic force generator can then produce magnetic forces which drive the CMP volume 1 along this displacement path, that is along the contacts or tracks 12, 13. Thus, without relative movement between the actuating device 15 and the contacts or tracks 12, 13 it is possible to produce a relative displacement of the CMP volume 1 in which only one corresponding magnetic field is positioned along the tracks or contacts 12, 13.

Other components containing electrical contacts which can be dynamically contacted using the electrically conducting, magnetic powder 1 according to the invention are, for example, a potentiometer as in FIGS. 4 to 7, which is additionally equipped with one or a plurality of switches, a switch, a sealed switch, a limit switch, a proximity switch, a step switch, an incremental encoder, an absolute encoder, a relay, a sealed relay and so on.

1. Electrically conducting, magnetic powder (1) comprising or made of electrically conducting and magnetic particles (2).

2. The powder according to claim 1,
characterised in
that the particles (2) are pre-magnetised so that they mutually attract.

3. The powder according to claim 1 or claim 2,
characterised in
that the particles (2) have an average grain size which is smaller than 50 μm or smaller than 40 μm or smaller than 35 μm.

4. The powder according to any one of claims 1 to 3,
characterised in
that the particles (2) are constructed as substantially spherical.

5. The powder according to any one of claims 1 to 4,
characterised in
that the electrically conducting, magnetic particles (2) have an electrically conducting coated magnetic core (4).

6. The powder according to claim 5,
characterised in
that the magnetic cores (4) consist of an electrically non-conducting material.

7. The powder according to claim 5 or claim 6,
characterised in
that the magnetic cores (4) consist of ferrite.

8. The powder according to any one of claims 5 to 7,
characterised in
that the magnetic cores (4) are coated with carbon or with a metal.

9. The powder according to any one of claims 1 to 8,
characterised in
that the particles (2) are inserted in a carrier liquid (3) to form an electrically conducting, magnetic liquid (1′).

10. The powder according to claim 9,
characterised in
that the carrier liquid (3) is electrically non-conducting and/or non-magnetic.

11. The powder according to claim 9 or claim 10,
characterised in
that the carrier liquid (3) is an oil.

12. The powder according to any one of claims 9 to 11,
characterised in
that the carrier liquid (3) has a relatively high surface tension.

13. The powder according to any one of claims 9 to 12,
characterised in
that the carrier liquid (3) is a non-migrating oil.

14. Use of an electrically conducting, magnetic powder (1), especially according to any one of claims 1 to 13, in an electrical component (6) for transferring an electrical signal and/or an electric voltage and/or an electric current between at least two electric contacts (12, 13).

15. An electrical component, especially a switch or potentiometer (6),
wherein the component (6) has at least two electrical contacts (12, 13),
wherein the component (6) has a transfer volume (11) comprising an electrically conducting, magnetic powder (1), especially according to any one of claims 1 to 13, or an electrically conducting, magnetic liquid (1′), especially according to any one of claims 9 to 13, for transferring an electrical signal and/or an electric voltage and/or an electric current between two of the contacts (12, 13),
wherein the component (6) has an actuating device (15) which, when actuated, displaces the transfer volume (11) by means of magnetic forces (14) relative to the contacts 12, 13).

16. The component according to claim 15,
characterised in
that the contacts (12, 13) and the transfer volume (11) are arranged in a casing (20),
that the actuating device (15) is arranged outside on the casing (20) or outside the casing (20),
that at least one wall (21) of the casing (20) is constructed as permeable for the magnetic forces (14) of the actuating device (15).

17. The component according to claim 15 or claim 16,
characterised in
that the actuating device (15) has an actuator (16) which has at least one magnet (18) for generating the magnetic forces (14) and is displaceable along a pre-determined displacement path for the actuating volume (11) relative to the contacts (12, 13).

18. The component according to claims 16 and 17,
characterised in
that the actuator (16) is displaceable along the casing (20) without contact.

19. The component according to claim 15 or claim 16,
characterised in
that the actuating device (15) has a magnetic force generator which is constructed in the fashion of a linear motor, which extends along a pre-determined displacement path for the actuating volume (11) and is used to generate magnetic forces (14) which drive the actuating volume (11) along the displacement path.

20. The component according to any one of claims 15 to 19,
characterised in
that the component is a potentiometer (6) whose collector track (13) and resistance track (12) respectively form a contact,
that the collector track (13) and resistance track (12) are arranged adjacent to one another without contact,
that the actuating volume (11) interconnects the collector track (13) and the resistance track (12),
that the relative position of the transfer volume (11) along the collector track (13) and along the resistance track (12) can be adjusted with the actuating device (15).

21. The component according to any one of claims 15 to 20,
characterised in
that the component (6) is a member of the following group of components: potentiometer, sealed potentiometer, potentiometer with built-in switch, switch, sealed switch, limit switch, proximity switch, step switch, incremental encoder, absolute encoder, relay, sealed relay.

22. Electrically conducting, magnetic liquid comprising a carrier liquid (3) containing a powder (1) according to any one of claims 1 to 13.
